(19) United States
(12) Patent Application Publication
(10) Pub. No.: US 2009/0316430 A1
(43) Pub. Date: Dec. 24, 2009

(54) BACKLIGHT MODULE

(75) Inventors: Fu-Ming Chuang, Hsin-Chu (TW); Tun-Chien Teng, Hsin-Chu (TW); Chih-Jen Tsang, Hsin-Chu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Coretronic Corporation, Hsin-Chu (TW)

(21) Appl. No.: 12/405,243

(22) Filed: Mar. 17, 2009

(30) Foreign Application Priority Data
Jun. 20, 2008 (TW) 97123186

(51) Int. Cl. F21V 7/22; G02F 1/13357

(52) U.S. Cl. 362/606; 362/97.1

(57) ABSTRACT

A backlight module including at least one light emitting element and a brightness enhancement diffuser is provided. The light emitting element is capable of emitting a light beam. The brightness enhancement diffuser is disposed in the transmission path of the light beam and has a first surface and a second surface opposite to the first surface. The light beam passes through the first surface and the second surface. The brightness enhancement diffuser includes a plurality of protrusions and a plurality of recesses. The protrusions are disposed on the first surface, and each of the protrusions has a curved surface. The recesses are disposed on the first surface, and each of the recesses has at least one plane surface. Each of the recesses is surrounded by several of the protrusions.

### CROSS-REFERENCE TO RELATED APPLICATION

This application claims the priority benefit of Taiwan application serial no. 97123186, filed on Jun. 20, 2008. The entirety of the above-mentioned patent application is hereby incorporated by reference herein and made a part of specification.

### BACKGROUND OF THE INVENTION

1. Field of the Invention

The invention generally relates to an optical film and a light source module, and more particularly, to a brightness enhancement diffuser having both a light converging function and a light diffusing function and a backlight module using the same.

2. Description of Related Art

FIG. 1A is a partial cross-sectional view of a conventional backlight module, and FIG. 1B is a perspective view of a brightness enhancement film (BEF) in FIG. 1A. Referring to FIG. 1A and FIG. 1B, a conventional backlight module 100 includes a reflector 110, a plurality of cold cathode fluorescent lamps (CCFLs) 120, a bottom diffuser 130, a BEF 140, and a top diffuser 150 disposed sequentially from the back to the front. The CCFLs 120 are capable of emitting a light beam 122. A part of the light beam 122 is emitted towards the reflector 110 and then reflected by the reflector 110 to the bottom diffuser 130 and transmitted to the BEF 140. On the other hand, another part of the light beam 122 is emitted directly towards the bottom diffuser 130 and transmitted to the BEF 140.

The BEF 140 has a plurality of prism structures 142 arranged parallel to each other, and these prism structures 142 are selective to the light beam 122 of different incident angle. Namely, the prism structures 142 only allow the light beam 122 having an incident angle within a specific range to pass through so that the light beam 122 emitted from the BEF 140 are as perpendicular to the top diffuser 150 as possible. Accordingly, a light converging function is achieved by the BEF 140. For example, a light ray 122a is capable of passing through the prism structures 142 and is transmitted to the top diffuser 150. However, light rays 122b and 122c are reflected by the prism structures 142 back to the reflector 110. The reflector 110 reflects the light rays 122b and 122c back to the BEF 140 so that the light rays 122b and 122c are reused. The prism structures 142 allow part of the reused light beam 122 to pass through and reflect another part of the reused light beam 122 again. Thus, part of the light beam 122 circulates many times between the prism structures 142 and the reflector 110 until it passes through the prism structures 142.

However, when the light beam 122 is emitted towards the BEF 140, each time only about less than 50% of the light beam 122 passes through the BEF 140, and the other about greater than 50% of the light beam 122 circulates between the prism structures 142 and the reflector 110. The more the number of the times of the part of the light beam 122 circulates between the prism structures 142 and the reflector 110, the more the light beam 122 is absorbed by various films. As a result, the optical efficiency of the backlight module 100 is reduced.

In addition, to prevent non-uniform surface light source provided by the backlight module 100 caused by the obvious profile of the prism structures 142 and to prevent moiré produced by the prism structures 142 and a pixel array (not shown) of a liquid crystal display (LCD) panel disposed above the backlight module 100, a top diffuser 150 has usually to be disposed above the BEF 140. As a result, the cost of the backlight module 100 is hard to be reduced. Moreover, the sharp ridges 144 of the prism structures 142 may hurt the adjacent optical films or the sharp ridges 144 themselves may be worn out. As a result, the reliability and durability of the backlight module 100 are reduced.

### SUMMARY OF THE INVENTION

Accordingly, the invention is directed to a backlight module, wherein both a light converging function and a light diffusing function are integrated into a brightness enhancement diffuser.

An embodiment of the invention provides a brightness enhancement diffuser having a first surface and a second surface opposite to the first surface. The brightness enhancement diffuser includes a plurality of protrusions and a plurality of first recesses. The protrusions are disposed on the first surface, wherein each of the protrusions has a first curved surface. The first recesses are disposed on the first surface, wherein each of the first recesses has at least one first plane surface, and each of the first recesses is surrounded by several of the protrusions.

Another embodiment of the invention provides a brightness enhancement diffuser having a first surface and a second surface opposite to the first surface. The brightness enhancement diffuser includes a plurality of first protrusions and a plurality of recesses. The first protrusions are disposed on the first surface, wherein each of the first protrusions has at least one first plane surface. The recesses are disposed on the first surface, wherein each of the recesses has a first curved surface, and each of the first protrusions is surrounded by several of the recesses.

Still another embodiment of the invention provides a brightness enhancement diffuser having a first surface and a second surface opposite to the first surface. The brightness enhancement diffuser includes a plurality of first protrusions and a plurality of second protrusions. The first protrusions are disposed on the first surface, wherein each of the first protrusions is formed by a curved surface. The second protrusions are disposed on the first surface, wherein each of the second protrusions has at least one first plane surface, and each of the second protrusions is surrounded by several of the first protrusions.

Yet still another embodiment of the invention provides a backlight module including at least one light emitting element and any one of aforementioned brightness enhancement diffusers. The light emitting element is capable of emitting a light beam. The brightness enhancement diffuser is disposed in the transmission path of the light beam. The light beam passes through the first surface and the second surface.

In the embodiments of the invention, optical structures of protrusions and recesses or optical structures of protrusions are formed on a brightness enhancement diffuser, and these optical structures have curved surfaces and plane surfaces. Since the curved surfaces may diffuse light and the plane surfaces may converge light, the brightness enhancement diffuser has both a light converging function and a light diffusing function. In this way, in a backlight module adopting such a brightness enhancement diffuser, both the light converging function and the light diffusing function may be integrated into a single optical film.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the embodiment of the invention, and are incorporated in and constitute a part of this specification. The drawings illustrate embodiments of the invention and, together with the description, serve to explain the principles of the invention.

FIG. 1A is a partial cross-sectional view of a conventional backlight module.

FIG. 1B is a perspective view of a brightness enhancement film (BEF) in FIG. 1A.

FIG. 2A is a perspective view of a brightness enhancement diffuser according to a first embodiment of the invention.

FIG. 2B is a partial perspective view of the brightness enhancement diffuser in FIG. 2A.

FIG. 2C is a cross-sectional view of the brightness enhancement diffuser in FIG. 2A along the line I-I.

FIG. 2D is a cross-sectional view of the brightness enhancement diffuser in FIG. 2A along the line II-II.

FIG. 2E is a cross-sectional view of the brightness enhancement diffuser in FIG. 2A along the line III-III.

FIG. 3 is a partial perspective view of a brightness enhancement diffuser according to a second embodiment of the invention.

FIG. 4A is a partial cross-sectional view of a brightness enhancement diffuser according to a third embodiment of the invention.

FIG. 4B is a partial perspective view of the brightness enhancement diffuser in FIG. 4A.

FIG. 5 is a partial cross-sectional view of a brightness enhancement diffuser according to a fourth embodiment of the invention.

FIG. 6A is a partial cross-sectional view of a brightness enhancement diffuser according to a fifth embodiment of the invention.

FIG. 6B is a partial perspective view of the brightness enhancement diffuser in FIG. 6A.

FIG. 7A is a partial perspective view of a brightness enhancement diffuser according to a sixth embodiment of the invention.

FIG. 7B is a partial cross-sectional view of the brightness enhancement diffuser in FIG. 7A along the line IV-IV.

FIG. 7C is a partial cross-sectional view of the brightness enhancement diffuser in FIG. 7A along the line V-V.

FIG. 8A is a partial perspective view of a brightness enhancement diffuser according to a seventh embodiment of the invention.

FIG. 8B is a partial cross-sectional view of the brightness enhancement diffuser in FIG. 8A along the line VI-VI.

FIG. 9 is a partial cross-sectional view of a brightness enhancement diffuser according to an eighth embodiment of the invention.

FIG. 10A is a partial perspective view of a brightness enhancement diffuser according to a ninth embodiment of the invention.

FIG. 10B is a partial cross-sectional view of the brightness enhancement diffuser in FIG. 10A along the line VII-VII.

FIG. 11 is a structure diagram of a backlight module according to a tenth embodiment of the invention.

FIG. 12 is a structure diagram of a backlight module according to an eleventh embodiment of the invention.

FIG. 13 is a structure diagram of a backlight module according to a twelfth embodiment of the invention.

FIG. 14 is a structure diagram of a backlight module according to a thirteenth embodiment of the invention.

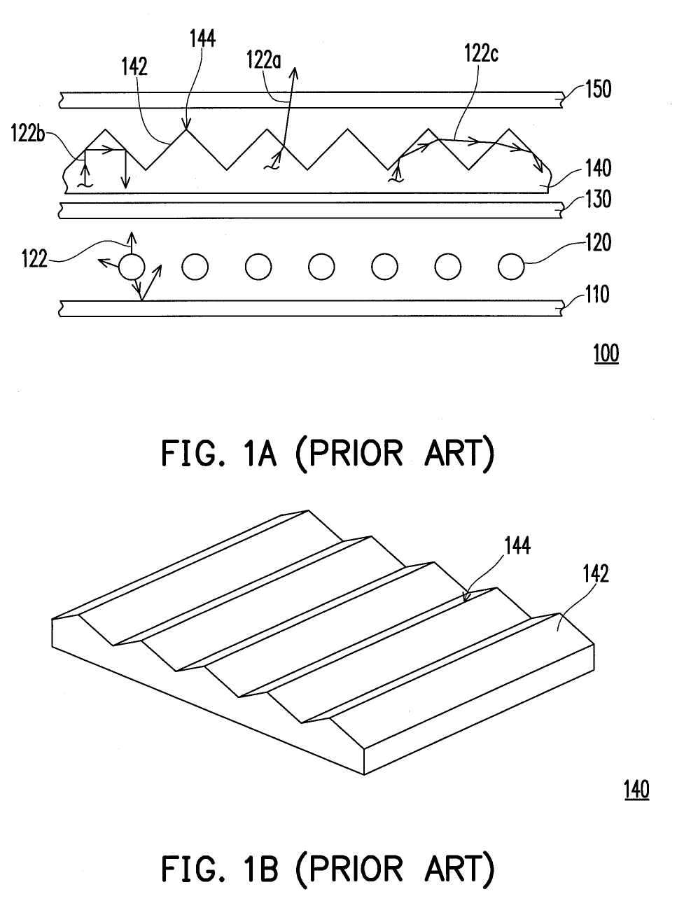

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

### First Embodiment

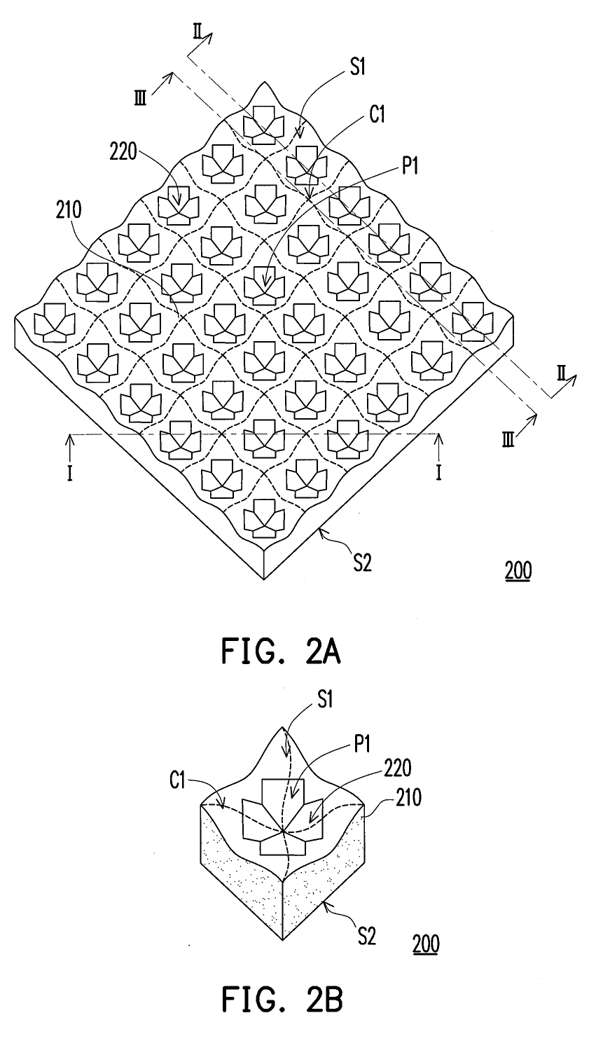

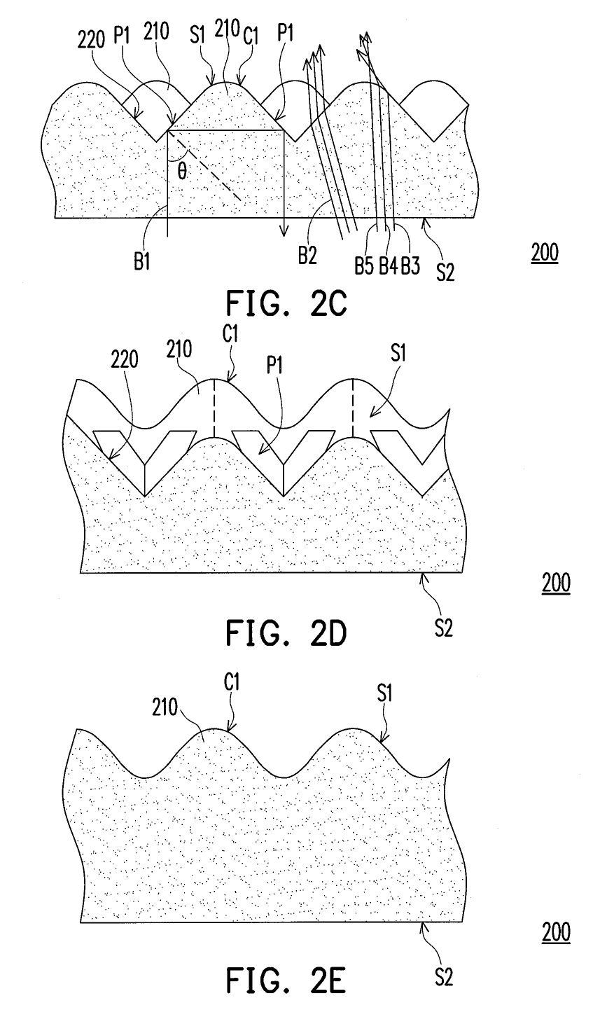

FIG. 2A is a perspective view of a brightness enhancement diffuser according to the first embodiment of the invention. FIG. 2B is a partial perspective view of the brightness enhancement diffuser in FIG. 2A. FIG. 2C is a cross-sectional view of the brightness enhancement diffuser in FIG. 2A along the line I-I. FIG. 2D is a cross-sectional view of the brightness enhancement diffuser in FIG. 2A along the line II-II. FIG. 2E is a cross-sectional view of the brightness enhancement diffuser in FIG. 2A along the line III-III. Referring to FIGS. 2A˜2E, in the present embodiment, a brightness enhancement diffuser 200 has a first surface S1 and a second surface S2 opposite to the first surface S1. The brightness enhancement diffuser 200 includes a plurality of protrusions 210 and a plurality of recesses 220. The protrusions 210 are disposed on the first surface S1, wherein each of the protrusions 210 has a curved surface C1. In the present embodiment, the protrusions 210 are formed by the curved surfaces C1. To be specific, the curved surfaces C1 may be smooth curved surfaces. However, in another embodiment of the invention, each of the curved surfaces C1 may also be composed of a plurality of micro planes.

The recesses 220 are disposed on the first surface S1, wherein each of the recesses 220 has at least one plane surface P1. In the present embodiment, each of the recesses 220 may be a polygonal-pyramid-shaped recess. To be specific, each of the recesses 220 has four plane surfaces P1, and the four plane surfaces P1 are connected to each other and form a quadrangular-pyramid-shaped recess. In the present embodiment, the recesses 220 may be polygonal-pyramid-shaped recesses having sharp apex angles. However, in another embodiment of the invention, the recesses may also be polygonal-pyramid-shaped recesses having round apex angles. The round apex angles make it easier to release the brightness enhancement diffuser from the mold when the brightness enhancement diffuser is fabricated by injection molding. In addition, each of the recesses 220 is surrounded by several of the protrusions 210. In the present embodiment, each of the recesses 220 is surrounded by four protrusions 210. Moreover, in the present embodiment, the second surface S2 is a plane surface.

Referring to FIG. 2C, in the present embodiment, a light beam B from a light source (not shown) enters the brightness enhancement diffuser 200 through the second surface S2 and is emitted out of the brightness enhancement diffuser 200 through the first surface S1. When a partial light beam B1 of the light beam B enters the brightness enhancement diffuser 200 in a direction about perpendicular to the second surface S2 and is incident on the plane surface P1, because the incident angle θ of the partial light beam B1 is greater than a critical angle, the partial light beam B1 is totally internally reflected by the plane surface P1 to an adjacent plane surface P1, and again the partial light beam B1 is totally internally reflected by the adjacent plane surface P1 to the second surface S2. Next, the partial light beam B1 passes through the second surface S2. When the brightness enhancement diffuser 200 is applied to a backlight module (not shown), a reflection unit (not shown) may be disposed at one side of the second surface S2 for reflecting the partial light beam B1 from the second surface S2 back to the brightness enhancement diffuser 200, so as to reuse the light.

When a partial light beam B2 of the light beam B obliquely passes through the second surface S2 and is incident on the plane surface P1, the plane surface P1 refracts the partial light beam B2 to allow the partial light beam B2 to leave the brightness enhancement diffuser 200 in a direction about perpendicular to the second surface S2, so as to achieve a light converging effect. Such a light converging effect is equal to the light converging effect of a general brightness enhancement film (BEF).

When partial light beams B3, B4, and B5 of the light beam B pass through the second surface S2 and are incident on the curved surface C1, because the curved surface C1 is curved, the partial light beams B3, B4, and B5 incident on different parts of the curved surface C1 have different incident angles. Accordingly, when the partial light beams B3, B4, and B5 pass through the curved surface C1, they are refracted by the curved surface C1 at different refraction angles so that the light beams B3, B4, and B5 are diffused towards different directions. Accordingly, a light diffusing effect is achieved. Such a light diffusing effect is similar to that of a general diffuser.

As described above, the brightness enhancement diffuser 200 in the present embodiment has both a light converging function and a light diffusing function. In other words, in the present embodiment, the light converging function and the light diffusing function are integrated into a single optical film. Thus, compared to the conventional technique wherein a BEF is used for converging light and a diffuser is used for diffusing light, less optical films are used in an optical system (for example, a backlight module) adopting the brightness enhancement diffuser 200 in the present embodiment, and accordingly, the cost of the system is reduced. In addition, when a light passes through the optical films, part of the energy thereof is absorbed by the optical films, which results in optical loss. Thus, by reducing the number of optical films used, the optical loss may be reduced and accordingly the optical efficiency of the optical system may be improved.

In addition, compared to the conventional technique wherein the prism structures of the BEF have very sharp ridges, the protrusions 210 of the brightness enhancement diffuser 200 in the embodiment are formed by the curved surface C1. Thus, the optical films adjacent to the brightness enhancement diffuser 200 are hard to be hurt or the protrusions 210 themselves are hard to be worn out.

Moreover, compared to the conventional technique wherein a light incident perpendicularly on the BEF circulates between the reflector and the BEF, the protrusions 210 of the brightness enhancement diffuser 200 in the present embodiment having the curved surface C1 allow both the partial light beam having a perpendicular incident angle (for example, the partial light beams B3, B4, and B5) and the partial light beam having an oblique incident angle (for example, the partial light beam B2) to pass through, so that the proportion and number of times of the light beam circulating between the brightness enhancement diffuser 200 and the reflection unit are both reduced. Thus, the brightness enhancement diffuser 200 has reduced optical loss and the optical efficiency of an optical system is effectively improved.

In the present embodiment, the curvature of the curved surface C1 and the slope of the plane surface P1 are changed according to the requirement to the beam shape or respectively optimized to control the field angle and the light converging effect of the emitted beam pattern. Besides, in the present embodiment, the curved surface C1 of each of the protrusions 210 has the same curvature, and the plane surface P1 of each of the recesses 220 has the same slope. However, in another embodiment of the present invention, the curvatures of the curved surfaces may be partially the same or completely different, and the slopes of the plane surfaces of the recesses may be partially the same or completely different. Besides, in the present embodiment, each of the protrusions 210 has the same size, and each of the recesses 220 also has the same size. However, in another embodiment of the present invention, the sizes of the protrusions may be partially the same or completely different, and the sizes of the recesses may be partially the same or completely different.

### Second Embodiment

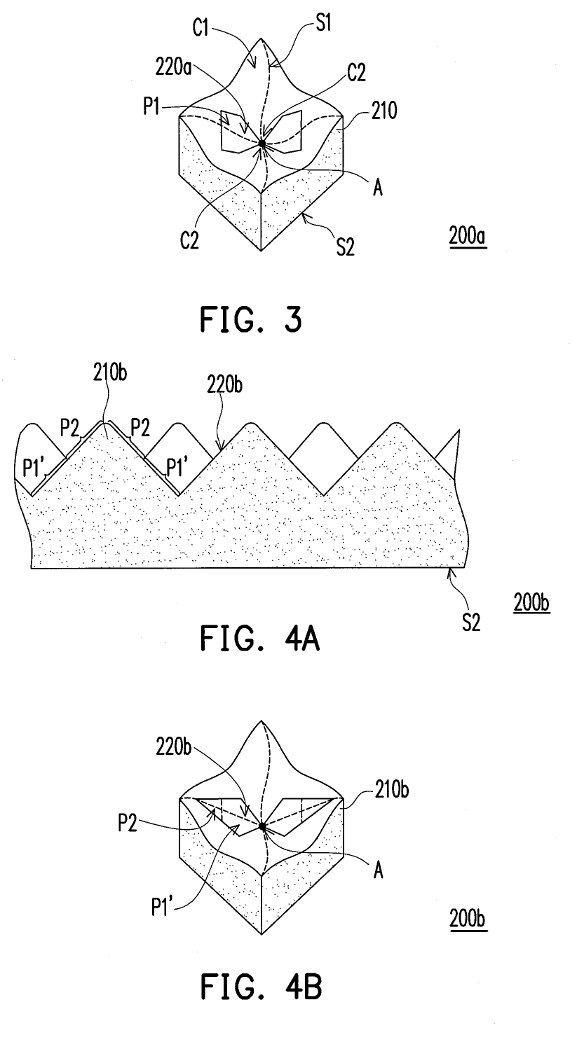

FIG. 3 is a partial perspective view of a brightness enhancement diffuser according to the second embodiment of the invention. Referring to FIG. 3, the brightness enhancement diffuser 200a in the present embodiment is similar to the brightness enhancement diffuser 200 (illustrated in FIG. 2B) described above, and the difference between them is described as following. In the brightness enhancement diffuser 200a of the present embodiment, each of the recesses 220a has a pair of plane surfaces P1, and the pair of plane surfaces P1 may be a pair of polygonal plane surfaces opposite to each other. In addition, in the present embodiment, each of the recesses 220a further has a pair of curved surfaces C2 opposite to each other, and each of the curved surfaces C2 is connected to the pair of plane surfaces P1 of each of the recesses 220a. Moreover, each pair of the plane surfaces P1 is connected through a common vertex A. However, in another embodiment of the invention, each pair of the plane surfaces P1 may also be connected through a round apex angle. The round apex angles make it easier to release the brightness enhancement diffuser from the mold when the brightness enhancement diffuser is fabricated by injection molding. In the present embodiment, each of the curved surfaces C2 may be a smooth curved surface. However, in another embodiment of the invention, each of the curved surfaces C2 may also be composed of a plurality of micro planes.

In the brightness enhancement diffuser 200a of the present embodiment, because each of the recesses 220a has two less plane surfaces P1 and two more curved surfaces C2 than each of the recesses 220 (illustrated in FIG. 2B), the brightness enhancing effect of the brightness enhancement diffuser 200a is not as strong as that of the brightness enhancement diffuser 200 (illustrated in FIG. 2A), but the light diffusing effect of the brightness enhancement diffuser 200a is stronger than that of the brightness enhancement diffuser 200.

It should be noted that in the embodiment of the invention, the numbers of the plane surfaces P1 and the curved surfaces C2 of each of the recesses 220a are not limited to two. In another embodiment of the invention, each of the recesses may have other number (more than one) of plane surfaces, and each of the recesses may also have other number (more than one) of curved surfaces. Besides, in the embodiment of the invention, the proportion between the number of plane surfaces P1 and the number of curved surfaces C2 of each of the recesses 220a is not limited to 1:1. In another embodiment of the invention, the proportion between the number of plane surfaces and the number of curved surfaces of each of the recesses may also have other appropriate value.

### Third Embodiment

FIG. 4A is a partial cross-sectional view of a brightness enhancement diffuser according to the third embodiment of the invention. FIG. 4B is a partial perspective view of the brightness enhancement diffuser in FIG. 4A. Referring to FIG. 4A and FIG. 4B, the brightness enhancement diffuser 200b in the present embodiment is similar to the brightness enhancement diffuser 200a (illustrated in FIG. 3) described above, and the difference between them is described as following. In the brightness enhancement diffuser 200b of the present embodiment, each of the protrusions 210b further has two plane surfaces P2 opposite to each other, and a plane surface P2 of each of the protrusions 210b is connected to a plane surface P1′ of an adjacent recess 220b and is coplanar with the plane surface P1′. Besides, in the present embodiment, the plane surface P2 is extended from the plane surface P1′ toward the vertex of the protrusion 210b.

Compared to the brightness enhancement diffuser 200a (illustrated in FIG. 3) described above, the brightness enhancement diffuser 200b in the present embodiments further has the plane surfaces P2. Thus, the light converging effect of the brightness enhancement diffuser 200b is stronger than that of the brightness enhancement diffuser 200a, but the light diffusing effect thereof is not as strong as that of the brightness enhancement diffuser 200a.

It should be noted that in the embodiment of the invention, the numbers of the plane surfaces P2 of each of the protrusions 210b and the plane surfaces P1′ of each of the recesses 220b are not limited to two. In another embodiment of the invention, each of the protrusions and each of the recesses may have other numbers (more than one) of plane surfaces.

### Fourth Embodiment

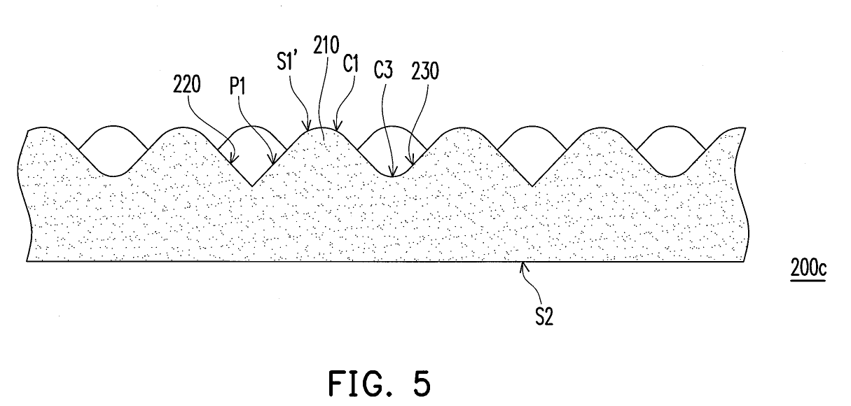

FIG. 5 is a partial cross-sectional view of a brightness enhancement diffuser according to the fourth embodiment of the invention. Referring to FIG. 5, the brightness enhancement diffuser 200c in the present embodiment is similar to the brightness enhancement diffuser 200 (illustrated in FIG. 2C) described above, and the difference between them is described as following. In the present embodiment, the brightness enhancement diffuser 200c further includes a plurality of recesses 230 disposed on the first surface S1′. Each of the recesses 230 is formed by a curved surface C3, and each of the recesses 230 is surrounded by several of the protrusions 210. In the present embodiment, each of the recesses 230 is surrounded by four protrusions 210. In other words, the brightness enhancement diffuser 200c is obtained by replacing some of the polygonal-pyramid-shaped recesses 220 in the brightness enhancement diffuser 200 (illustrated in FIG. 2A) with the recesses 230 formed by the curved surfaces C3.

Compared to the brightness enhancement diffuser 200 (illustrated in FIG. 2A), the brightness enhancement diffuser 200c in the present embodiment further includes the recesses 230 formed by the curved surfaces C3 but does not have the polygonal-pyramid-shaped recesses 220. Thus, the light diffusing effect of the brightness enhancement diffuser 200c is stronger than that of the brightness enhancement diffuser 200, and the light converging effect thereof is not as strong as that of the brightness enhancement diffuser 200. The proportion between the recesses 220 and the recesses 230 in the brightness enhancement diffuser 200c may be adjusted according to the actual requirement to the light converging effect and light diffusing effect. The more recesses 230 the brightness enhancement diffuser has, the stronger the light diffusing effect is while the weaker the light converging effect is. Contrarily, the less recesses 230 the brightness enhancement diffuser has, the weaker the light diffusing effect is while the stronger the light converging effect is.

### Fifth Embodiment

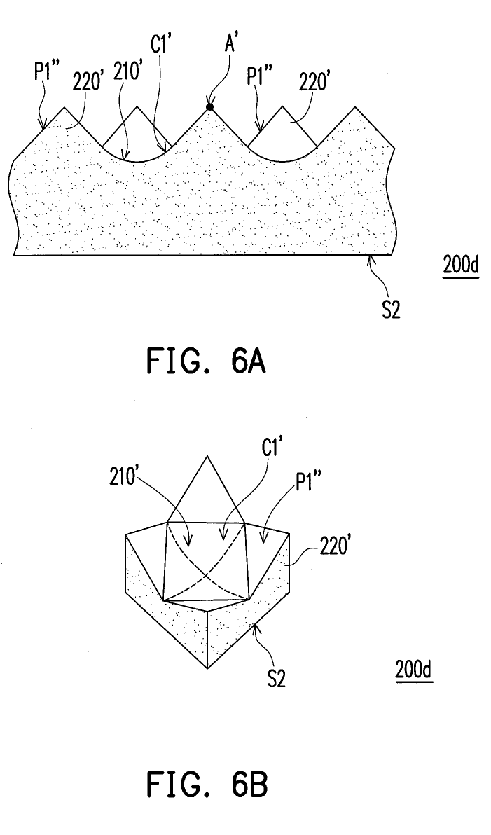

FIG. 6A is a partial cross-sectional view of a brightness enhancement diffuser according to the fifth embodiment of the invention. FIG. 6B is a partial perspective view of the brightness enhancement diffuser in FIG. 6A. Referring to FIG. 6A and FIG. 6B, the brightness enhancement diffuser 200d in the present embodiment is similar to the brightness enhancement diffuser 200 (illustrated in FIG. 2A) described above, and the difference between them is described as following. In the brightness enhancement diffuser 200d of the present embodiment, the protrusions 210 disposed in the brightness enhancement diffuser 200 (illustrated in FIG. 2A) are replaced with recesses 210′, and the recesses 220 disposed in the brightness enhancement diffuser 200 (illustrated in FIG. 2A) are replaced with protrusions 220′.

Each of the protrusions 220′ has at least one plane surface P1″. In the present embodiment, each of the protrusions 220′ may be a polygonal-pyramid-shaped protrusion. To be specific, the protrusion 220′ may have four plane surfaces P1″ connected to each other and form a quadrangular-pyramid-shaped protrusion. The protrusions 220′ may be polygonal-pyramid-shaped protrusions having sharp apex angles. However, in another embodiment of the invention, the protrusions 220′ may also be polygonal-pyramid-shaped protrusions having round apex angles. Besides, each of the recesses 210′ has a curved surface C1′ and each of the protrusions 220′ is surrounded by several of the recesses 210′. In the present embodiment, each of the protrusions 220′ is surrounded by four recesses 210′. In addition, in the present embodiment, the curved surface C1′ is a smooth curved surface. However, in another embodiment of the invention, the curved surface C1′ may also be composed of a plurality of micro planes. The optical effect of the brightness enhancement diffuser 200d in the present embodiment is similar to that of the brightness enhancement diffuser 200 (illustrated in FIG. 2A) and therefore will not be described herein.

### Sixth Embodiment

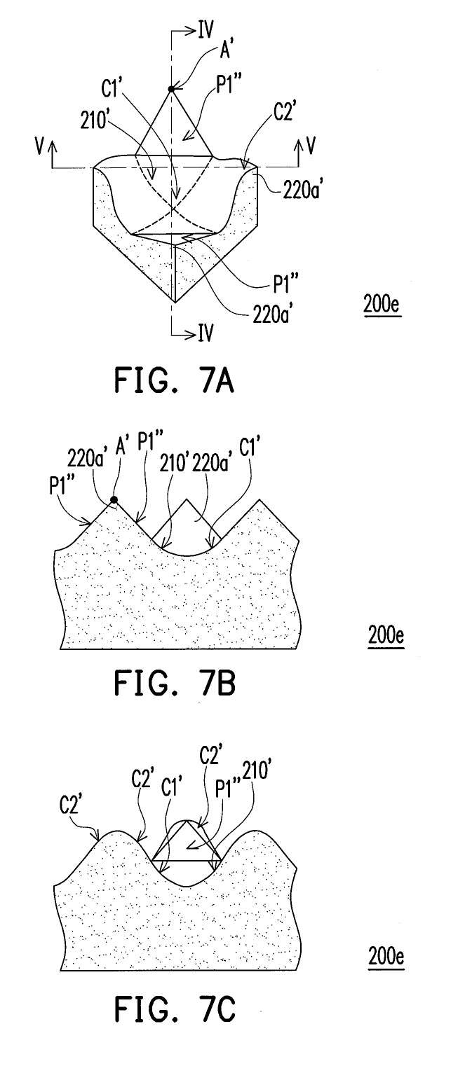

FIG. 7A is a partial perspective view of a brightness enhancement diffuser according to the sixth embodiment of the invention. FIG. 7B is a partial cross-sectional view of the brightness enhancement diffuser in FIG. 7A along the line IV-IV. FIG. 7C is a partial cross-sectional view of the brightness enhancement diffuser in FIG. 7A along the line V-V. Referring to FIGS. 7A˜7C, the brightness enhancement diffuser 200e in the present embodiment is similar to the brightness enhancement diffuser 200d (illustrated in FIG. 6B) described above, and the difference between them is described as following. In the brightness enhancement diffuser 200e of the present embodiment, each of the protrusions 220a′ has a pair of plane surfaces P1″ and the pair of plane surfaces P1″ may be a pair of polygonal plane surfaces opposite to each other. Besides, in the present embodiment, each of the protrusions 220a′ further has a pair of curved surfaces C2′ opposite to each other, and each of the curved surfaces C2′ is connected to the pair of plane surfaces P1″ of each of the protrusions 220a′. Moreover, each pair of the plane surfaces P1″ may be connected through a common vertex A′. However, in another embodiment of the invention, each pair of the plane surfaces P1″ may also be connected through a round angle. In the present embodiment, each of the curved surfaces C2′ is a smooth curved surface. However, in another embodiment of the invention, each of the curved surfaces C2′ may also be composed of a plurality of micro planes.

### Seventh Embodiment

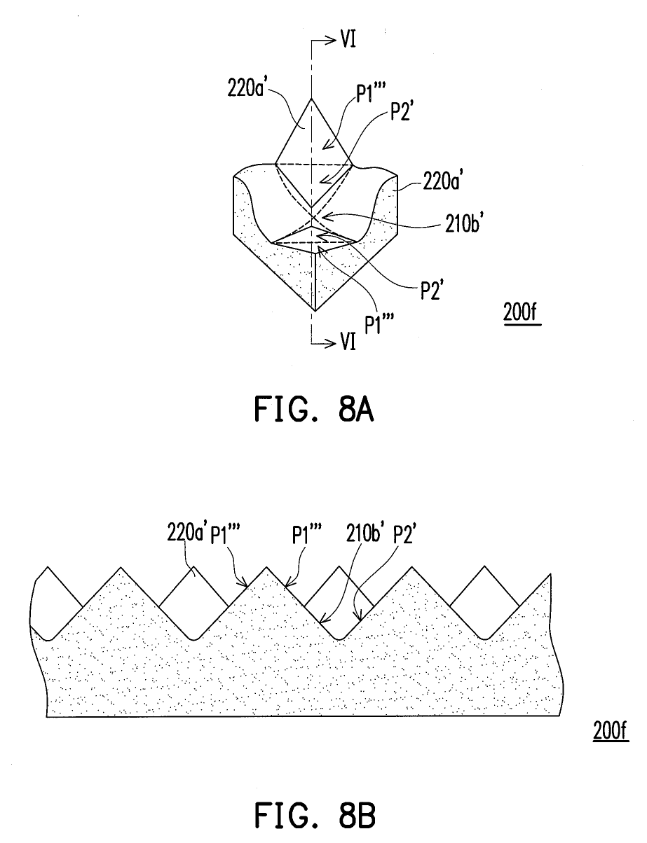

FIG. 8A is a partial perspective view of a brightness enhancement diffuser according to the seventh embodiment of the invention. FIG. 8B is a partial cross-sectional view of the brightness enhancement diffuser in FIG. 8A along the line VI-VI. Referring to FIG. 8A and FIG. 8B, the brightness enhancement diffuser 200f in the present embodiment is similar to the brightness enhancement diffuser 200e (illustrated in FIG. 7A) described above, and the difference between them is described as following. In the brightness enhancement diffuser 200f of the present embodiment, each of the recesses 210b′ further has two plane surfaces P2′ opposite to each other, and a plane surface P2′ of each of the recesses 210b′ is connected with a plane surface P1′″ of an adjacent protrusion 220a′ and is coplanar with the plane surface P1′″. Besides, in the present embodiment, the plane surface P2′ is extended from the plane surface P1′″ towards the bottom of the recess 210b′.

### Eighth Embodiment

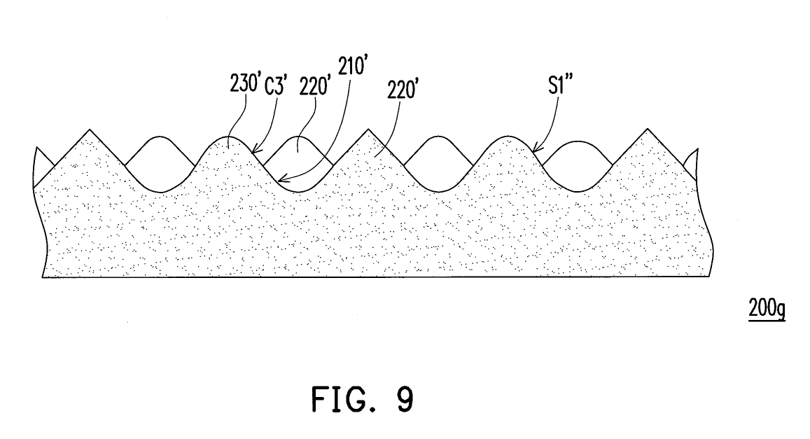

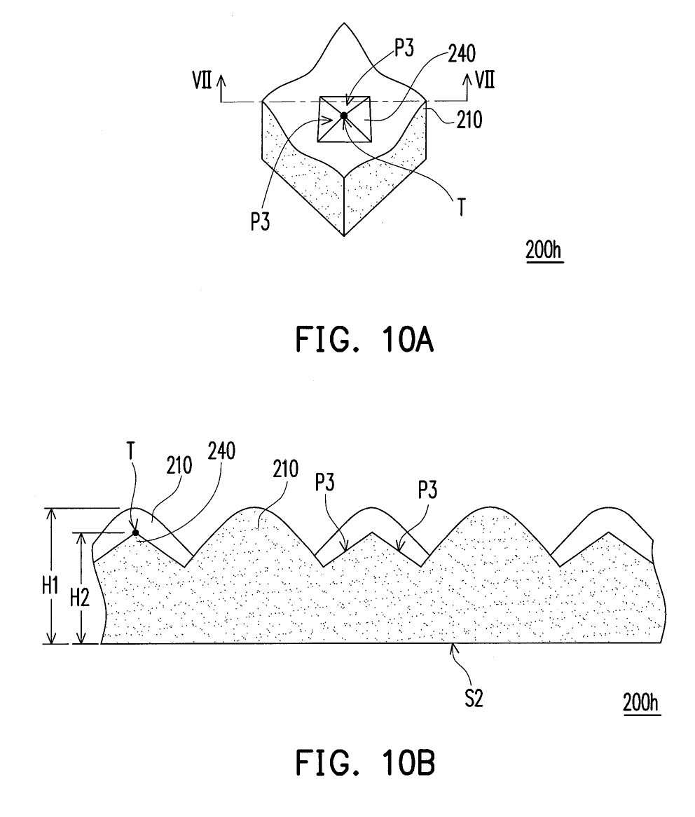

FIG. 9 is a partial cross-sectional view of a brightness enhancement diffuser according to the eighth embodiment of the invention. Referring to FIG. 9, the brightness enhancement diffuser 200g in the present embodiment is similar to the brightness enhancement diffuser 200d (illustrated in FIG. 6B) described above, and the difference between them is described as following. In the present embodiment, the brightness enhancement diffuser 200g further includes a plurality of protrusions 230′ disposed on the first surface S1″. Each of the protrusions 230′ is formed by a curved surface C3′ and each of the protrusions 230′ is surrounded by several of the recesses 210′. In the present embodiment, each of the protrusions 230′ is surrounded by four recesses 210′. In other words, the brightness enhancement diffuser 200g is obtained by replacing some of the polygonal-pyramid-shaped protrusions 220′ in the brightness enhancement diffuser 200d (illustrated in FIG. 6B) with the protrusions 230′ formed by the curved surfaces C3′.

Compared to the brightness enhancement diffuser 200d (illustrated in FIG. 6B), the brightness enhancement diffuser 200g in the present embodiment further includes the protrusions 230′ formed by the curved surfaces C3′ but does not have the polygonal-pyramid-shaped protrusions 220′. Thus, the light diffusing effect of the brightness enhancement diffuser 200g is stronger than that of the brightness enhancement diffuser 200d, but the light converging effect thereof is not as strong as that of the brightness enhancement diffuser 200d. The proportion between the protrusions 220′ and the protrusions 230′ in the brightness enhancement diffuser 200g may be adjusted according to the actual requirement to the light converging effect and light diffusing effect. The more protrusions 230′ the brightness enhancement diffuser 200g has, the stronger the light diffusing effect is while the weaker the light converging effect is. Contrarily, the less protrusions 230′ the brightness enhancement diffuser 200g has, the weaker the light diffusing effect is and the stronger the light converging effect is.

### Ninth Embodiment

FIG. 10A is a partial perspective view of a brightness enhancement diffuser according to the ninth embodiment of the invention. FIG. 10B is a partial cross-sectional view of the brightness enhancement diffuser in FIG. 10A along the line VII-VII. Referring to FIG. 10A and FIG. 10B, the brightness enhancement diffuser 200h in the present embodiment is similar to the brightness enhancement diffuser 200 (illustrated in FIG. 2A) described above, and the difference between them is described as following. The brightness enhancement diffuser 200h of the present embodiment is obtained by replacing the recesses 220 in the brightness enhancement diffuser 200 (illustrated in FIG. 2A) with the protrusions 240. Each of the protrusions 240 has at least one plane surface P3. In the present embodiment, each of the protrusions 240 has four plane surfaces P3 which are connected with each other and form a pyramid-shaped protrusion.

The optical effect of the brightness enhancement diffuser 200h is similar to that of the brightness enhancement diffuser 200 (illustrated in FIG. 2A), and therefore will not be described herein. In addition, in the present embodiment, the distance H1 from the peaks of the protrusions 210 to the second surface S2 is greater than the distance H2 from the peaks of the protrusions 240 to the second surface S2. Accordingly, the tips T of the protrusions 240 are hard to hurt the optical film adjacent to the brightness enhancement diffuser 200, or the tips T themselves are hard to be worn out by the adjacent optical film.

### Tenth Embodiment

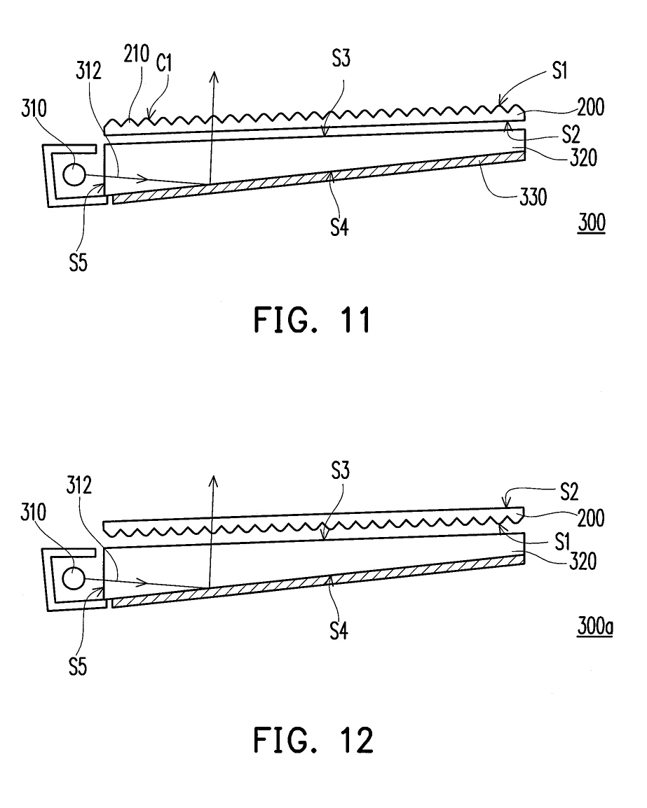

FIG. 11 is a structure diagram of a backlight module according to the tenth embodiment of the invention. Referring to FIG. 11, in the present embodiment, the backlight module 300 includes a light emitting element 310 and a brightness enhancement diffuser 200 (illustrated in FIG. 2A) as described above. The light emitting element 310 is capable of emitting a light beam 312. In the present embodiment, the light emitting element 310 may be a cold cathode fluorescent lamp (CCFL). However, in another embodiment of the present invention, the CCFL in the present embodiment may also be replaced with a plurality of light emitting diodes (LEDs) or other suitable light emitting elements. The brightness enhancement diffuser 200 is disposed in the transmission path of the light beam 312. In the present embodiment, the light beam 312 sequentially passes through the second surface S2 and the first surface S1 of the brightness enhancement diffuser 200.

In addition, in the present embodiment, the backlight module 300 further includes a light guide plate (LGP) 320 disposed at one side of the brightness enhancement diffuser 200. The LGP 320 has a third surface S3, a fourth surface S4, and a light incident surface S5. The third surface S3 faces the brightness enhancement diffuser 200, the fourth surface S4 is opposite to the third surface S3, and the light incident surface S5 is connected to the third surface S3 and the fourth surface S4. The light beam 312 emitted by the light emitting element 310 enters the LGP 320 through the light incident surface S5 and is transmitted to the brightness enhancement diffuser 200 through the third surface S3. In the present embodiment, a reflection unit 330 may be disposed at one side of the third surface S3 for reflecting the light beam 312 from the LGP 320 to the third surface S3.

In the backlight module 300 of the present embodiment, because the brightness enhancement diffuser 200 has both a light converging function and a light diffusing function, it is not necessary to dispose a diffuser at the other side of the brightness enhancement diffuser 200 which is opposite to the LGP 320, and a diffuser between the brightness enhancement diffuser 200 and the LGP 320 may also be skipped according to the actual requirement. Thus, in the backlight module 300 of the present embodiment, the number of optical films used may be reduced and accordingly both the optical loss and the cost of the backlight module 300 are reduced. In addition, when a liquid crystal display (LCD) panel (not shown) is disposed above the backlight module 300 to form a LCD apparatus (not shown), the moiré produced by the protrusions 210 and the pixels of the LCD panel is not very obvious because the protrusions 210 in the brightness enhancement diffuser 200 are formed by the curved surfaces C1. Accordingly, the display quality of the LCD apparatus is improved.

It should be noted that in the present embodiment, the brightness enhancement diffuser 200 may also be replaced by a brightness enhancement diffuser (for example, the brightness enhancement diffusers 200a˜200h) described in foregoing embodiments.

### Eleventh Embodiment

FIG. 12 is a structure diagram of a backlight module according to the eleventh embodiment of the invention. Referring to FIG. 12, the backlight module 300a in the present embodiment is similar to the backlight module 300 (illustrated in FIG. 11) described above, and the difference between them is described as following. In the backlight module 300a, the first surface S1 of the brightness enhancement diffuser 200 faces the LGP 320 to allow the light beam 312 to pass through the first surface S1 and the second surface S2 sequentially. The brightness enhancement diffuser 200 in the present embodiment may also be replaced by a brightness enhancement diffuser (for example, the brightness enhancement diffusers 200a˜200h) described in foregoing embodiments.

### Twelfth Embodiment

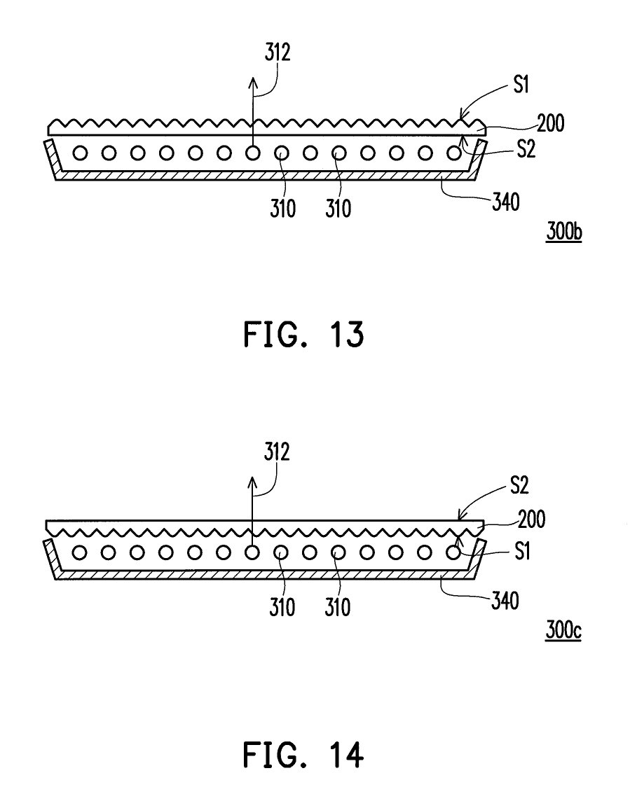

FIG. 13 is a structure diagram of a backlight module according to the twelfth embodiment of the invention. Referring to FIG. 13, the backlight module 300b in the present embodiment is similar to the backlight module 300 (illustrated in FIG. 11) described above, and the difference between them is described as following. The backlight module 300b in the present embodiment does not have the LGP 320, and a plurality of light emitting elements 310 are disposed at one side of the brightness enhancement diffuser 200 and capable of emit a light beam 312 toward the brightness enhancement diffuser 200. To be specific, the light emitting elements 310 are fixed on a light box 340, wherein the light box 340 may be a reflection unit with a light reflection function. In the present embodiment, the second surface S2 of the brightness enhancement diffuser 200 faces the light emitting elements 310 to allow the light beam 312 to pass through the second surface S2 and the first surface S1 sequentially. In addition, the brightness enhancement diffuser 200 in the present embodiment may also be replaced by a brightness enhancement diffuser (for example, the brightness enhancement diffusers 200a˜200h) described in foregoing embodiments.

### Thirteenth Embodiment

FIG. 14 is a structure diagram of a backlight module according to the thirteenth embodiment of the invention. Referring to FIG. 14, the backlight module 300c in the present embodiment is similar to the backlight module 300b (illustrated in FIG. 13) described above, and the difference between them is described as following. In the backlight module 300c of the present embodiment, the first surface S1 of the brightness enhancement diffuser 200 faces the light emitting elements 310 to allow the light beam 312 to pass through the first surface S1 and the second surface S2 sequentially. In addition, the brightness enhancement diffuser 200 in the present embodiment may also be replaced by a brightness enhancement diffuser (for example, the brightness enhancement diffusers 200a˜200h) described in foregoing embodiments.

In overview, in the embodiments of the invention, optical structures of protrusions and recesses or optical structures of protrusions are formed on a brightness enhancement diffuser, and these optical structures have curved surfaces and plane surfaces. Since the curved surfaces may diffuse light and the plane surfaces may converge light, the brightness enhancement diffuser in the embodiments of the invention has both a light converging function and a light diffusing function. In other words, both the light converging function and the light diffusing function may be integrated into a single optical film. As such, compared to a conventional backlight module which uses a BEF for converging light and an additional diffuser for diffusing light, a backlight module adopting the brightness enhancement diffuser in the embodiments of the invention may have reduced number of optical films and accordingly the cost thereof may be reduced. Moreover, when a light beam passes through the optical films, part of the energy thereof is absorbed by the optical films and accordingly optical loss is caused. Thereby, by reducing the number of optical films used, the optical loss may be reduced and accordingly the optical efficiency of the backlight module may be improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising:
at least one light emitting element, capable of emitting a light beam; and
a brightness enhancement diffuser, disposed in the transmission path of the light beam and having a first surface and a second surface opposite to the first surface, wherein the light beam is capable of passing through the first surface and the second surface, and the brightness enhancement diffuser comprises:
a plurality of protrusions, disposed on the first surface, wherein each of the protrusions has a first curved surface; and
a plurality of first recesses, disposed on the first surface, wherein each of the first recesses has at least one first plane surface, and each of the first recesses is surrounded by several of the protrusions.

2. The backlight module according to claim 1, wherein the second surface comprises a plane surface.

3. The backlight module according to claim 1, wherein each of the first recesses comprises a polygonal-pyramid-shaped recess.

4. The backlight module according to claim 1, wherein the at least one first plane surface of each of the first recesses comprises four first plane surfaces, and the four first plane surfaces are connected to each other and form a quadrangular-pyramid-shaped recess.

5. The backlight module according to claim 1, wherein the at least one first plane surface of each of the first recesses comprises a pair of polygonal plane surfaces opposite to each other.

6. The backlight module according to claim 5, wherein each of the first recesses further has a pair of second curved surfaces opposite to each other, and each of the second curved surfaces is connected to the pair of the polygonal plane surfaces of each of the first recesses.

7. The backlight module according to claim 5, wherein each of the protrusions further has two second plane surfaces opposite to each other, and each of the second plane surfaces is connected to the first plane surface adjacent thereto and is coplanar with the adjacent first plane surface.

8. The backlight module according to claim 7, wherein each of the second plane surfaces is extended from the first plane surface toward a vertex of the protrusion.

9. The backlight module according to claim 1, wherein the brightness enhancement diffuser further comprises a plurality of second recesses disposed on the first surface, wherein each of the second recesses is formed by a third curved surface, and each of the second recesses is surrounded by several of the protrusions.

10. The backlight module according to claim 1 further comprising a light guide plate disposed at one side of the brightness enhancement diffuser, wherein the light guide plate comprises:
a third surface, facing the brightness enhancement diffuser;
a fourth surface, opposite to the third surface; and
a light incident surface, connected to the third surface and the fourth surface, wherein the light beam emitted by the light emitting element is capable of entering the light guide plate through the light incident surface and being transmitted to the brightness enhancement diffuser through the third surface.

11. A backlight module, comprising:
at least one light emitting element, capable of emitting a light beam; and
a brightness enhancement diffuser, disposed in the transmission path of the light beam and having a first surface and a second surface opposite to the first surface, wherein the light beam is capable of passing through the first surface and the second surface, and the brightness enhancement diffuser comprises:
a plurality of first protrusions, disposed on the first surface, wherein each of the first protrusions has at least one first plane surface; and
a plurality of recesses, disposed on the first surface, wherein each of the recesses has a first curved surface, and each of the first protrusions is surrounded by several of the recesses.

12. The backlight module according to claim 11, wherein each of the first protrusions comprises a polygonal-pyramid-shaped protrusion.

13. The backlight module according to claim 11, wherein the at least one first plane surface of each of the first recesses comprises four first plane surfaces, and the four first plane surfaces are connected to each other and form a quadrangular-pyramid-shaped protrusion.

14. The backlight module according to claim 11, wherein the at least one first plane surface of each of the first protrusions comprises a pair of polygonal plane surfaces opposite to each other.

15. The backlight module according to claim 14, wherein each of the first protrusions further has a pair of second curved surfaces opposite to each other, and each of the second curved surfaces is connected to the pair of the polygonal plane surfaces of each of the first protrusions.

16. The backlight module according to claim 14, wherein each of the recesses further has two second plane surfaces opposite to each other, and each of the second plane surfaces is connected to the first plane surface adjacent thereto and is coplanar with the adjacent first plane surface.

17. The backlight module according to claim 16, wherein each of the second plane surfaces is extended from the first plane surface toward a bottom of the recess.

18. The backlight module according to claim 11, wherein the brightness enhancement diffuser further comprises a plurality of second protrusions disposed on the first surface, wherein each of the second protrusions is formed by a third curved surface, and each of the second protrusions is surrounded by several of the recesses.

19. The backlight module according to claim 11 further comprising an light guide plate disposed at one side of the brightness enhancement diffuser, wherein the light guide plate comprises:
a third surface, facing the brightness enhancement diffuser;
a fourth surface, opposite to the third surface; and
a light incident surface, connected to the third surface and the fourth surface, wherein the light beam emitted by the light emitting element is capable of entering the light guide plate through the light incident surface and being transmitted to the brightness enhancement diffuser through the third surface.

20. A backlight module, comprising:
at least one light emitting element, capable of emitting a light beam; and
a brightness enhancement diffuser, disposed in the transmission path of the light beam and having a first surface and a second surface opposite to the first surface, wherein the light beam is capable of passing through the first surface and the second surface, and the brightness enhancement diffuser comprises:
a plurality of first protrusions, disposed on the first surface, wherein each of the first protrusions is formed by a curved surface; and
a plurality of second protrusions, disposed on the first surface, wherein each of the second protrusions has at least one first plane surface, and each of the second protrusions is surrounded by several of the first protrusions.

21. The backlight module according to claim 20 further comprising a light guide plate disposed at one side of the brightness enhancement diffuser, wherein the light guide plate comprises:
a third surface, facing the brightness enhancement diffuser;
a fourth surface, opposite to the third surface; and
a light incident surface, connected to the third surface and the fourth surface, wherein the light beam emitted by the light emitting element is capable of entering the light guide plate through the light incident surface and being transmitted to the brightness enhancement diffuser through the third surface.
